(19) United States
(12) Patent Application Publication
(10) Pub. No.: US 2006/0108907 A1
(43) Pub. Date: May 25, 2006

(54) Electron emission device and its manufacture method

(76) Inventor: Yasushi Sano, (US)

Correspondence Address: Yasushi Sano, 2-854-1-110, Ohnocho, Ichikawa-shi, Chiba, 272-0805, JP

(21) Appl. No.: 10/995,003

(22) Filed: Nov. 23, 2004

(51) Int. Cl. H01J 1/02; H01J 1/00; H01J 1/14

(52) U.S. Cl. 313/310; 313/495; 313/309; 313/311

(57) ABSTRACT

The present investigation relate to an electron emission device which is composed by an insulated board in which a cathode electrode, an electron emission film, a gate insulation film, and a gate electrode were arranged, and an anode electrode estranged above said insulated board, and characterized by that an electron emission film is exposed to a bottom of an emitter hole provided in said gate insulation film on said insulated board, and an electron emission film in a part for an emitter hole central part being in a low position rather than an electron emission film of an emitter hole deep pool contiguity portion.

### BACKGROUND OF THE INVENTION

1. Field of the Invention

This invention relates to an electron emission device and its manufacture method.

2. Prior Art

The technology about the cold emission device which used the carbon nanotube is described by U.S. Pat. No. 6,436,221A. The structure as a cold emission device of the carbon nanotube (CNT) described by this patent is explained using FIG. 1. FIG. 1 is the composition of a cathode panel 1. In said cathode panel, via the gate insulation film 2, a gate wiring 3 and a cathode wiring 4 intersect perpendicularly mutually arranged. The portion which removed the gate wiring and the gate insulation film in cylindrical hole form is one of the intersection portions of a gate wiring and a cathode wiring, and this portion is called an emitter hole 5. Carbon nanotube content paste (it is henceforth called a CNT paste) is applied to the bottom of said emitter hole as an electron emission film 6. The section structure of this structure is shown in FIG. 2. The cathode wiring 4, the gate insulation film 2, and the gate wiring 3 are arranged on the cathode panel 1. The opening (emitter hole) is provided in the gate wiring 3 and the gate insulation film 2, and the CNT paste which contacted the cathode electrode electrically has accumulated on the bottom as an electron emission film 6. Via a vacuum, a fluorescence panel 7 is arranged with counters position to a cathode panel 1. In the composition shown in FIGS. 1 and 2, the depth of the hole of the emitter hole sets 20 micrometers, and the hole diameter sets 30 micrometers, the distance between the fluorescence panel and a cathode panel is 1.5 mm. The bottom of an emitter hole is flat or has a hill shape in the center part.

### SUMMARY OF THE INVENTION

This invention is intended to provide an electron emission device characterized by that an electron emission film is exposed to a bottom of an emitter hole provided in said gate insulation film in an insulated board in which a cathode electrode, an electron emission film, a gate insulation film, and a gate electrode were arranged, and an electron emission device which an anode electrode estranged above said insulated board, and was arranged in it, and an electron emission film in a part for an emitter hole central part being in a low position rather than an electron emission film of an emitter hole deep pool contiguity portion.

Prior arts have some problems. In the electron emission device of the structure shown in FIG. 2, failure operation called a diode action is one of the serious problems. This problem is explained in follow lines. The electronic-discharge phenomenon from an electron emission film is explained to the structure which the hole diameter of an emitter hole says 30 micrometers, and the depth says that the distance of 20 micrometers, a fluorescence panel, and a gate wiring is infinite, and the thickness of 1480 micrometers and a gate wiring is thin in FIG. 2. The CNT electron emission film emits electrons from the surface in the electric field condition of 1 kV/mm or more, and emits enough amounts of electrons for bright fluorescence light in 3 kV/mm electric field. The typical operation condition is that pulse electric signal of −30V/0V applies to the cathode wiring, and that of 0V/+30V applies to the gate wiring. The electron emission film emits electrons when the cathode and gate wirings are applied to −30V and +30V, respectively, because the electric field (60V/20 micrometers=3 kV/mm) by the applied voltages. The electron emission film does not emit an electron, when a gate electrode, a cathode electrode, or one of applied voltage is 0V. The typical applied voltage on the fluorescence panel is 5970V. In this case, the center part of the electron emission film is actually applied approximately 4 kV, because the emitter hole widely open to the fluorescence panel and the potential difference and distance between the electric field and fluorescence panel are 6,000V and 15000 microns. In this actual case, the electron emission can not be controlled by the gate and cathode wiring applied voltages. It is a problem This problem is commonly called as a diode action problem. This invention can solve this diode action problem with low cost.

### BRIEF EXPLANATION OF THE DRAWINGS

FIG. 1 is the composition figure showing the conventional composition.

FIG. 2 is the composition figure showing the conventional structure.

FIG. 3 is the composition figure showing the structure of the embodiment 1 of this invention.

FIG. 4 is the composition figure showing the 1st state of the embodiment 2 of this invention.

FIG. 5 is t the composition figure showing the 2nd state of the embodiment 2 of this invention.

FIG. 6 is the composition figure showing the 1st process of the embodiment 3 of this invention.

FIG. 7 is the composition figure showing the 2nd process of the embodiment 3 of this invention.

FIG. 8 is the composition figure showing the 3rd process of the embodiment 3 of this invention.

FIG. 9 is the composition figure showing the 4th process of the embodiment 3 of this invention.

FIG. 10 is the composition figure showing the 5th process of the embodiment 3 of this invention.

1. a cathode panel
2. a gate insulation film
3. a gate wiring
4. a cathode wiring
5. an emitter hole
6. an electron emission film
7. a fluorescence panel
8. a doughnut-like domain
9. a cone well shape domain
10. a photo resist film
11. a cover film
12. a sticky paste

### DETAILED DESCRIPTION OF THE PREFERED EMBODIMENT

### The First Embodiment

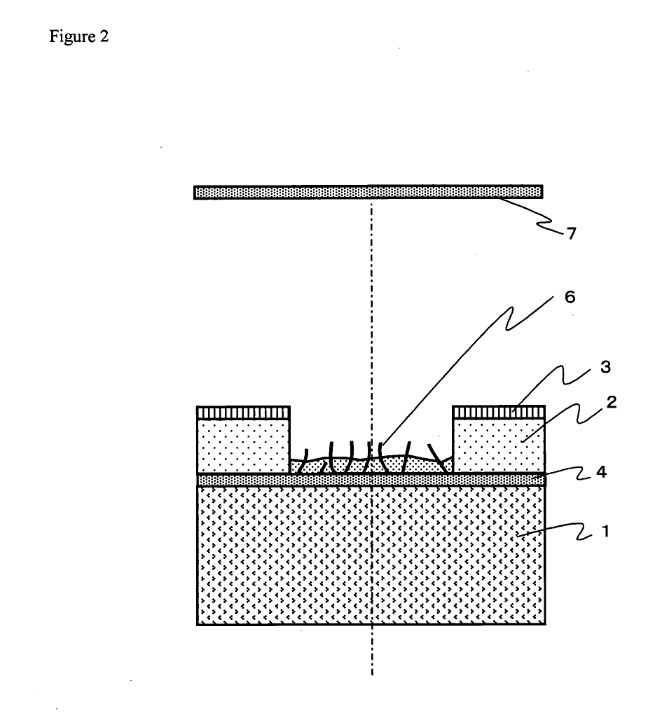

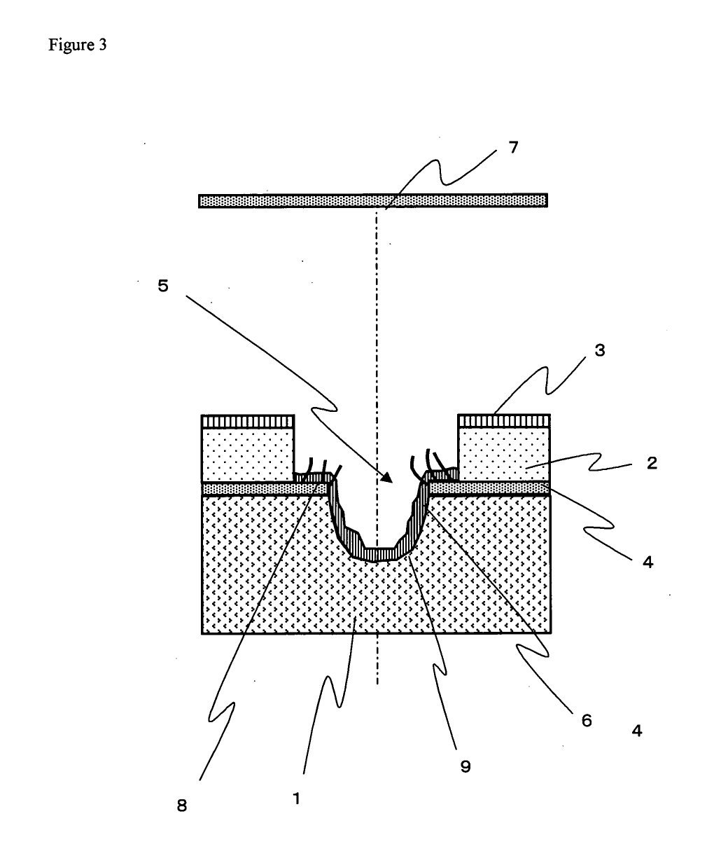

The embodiment 1 of this invention is explained. FIG. 3 is an emitter hole 5 of this invention electron emission device. The main difference from the conventional structure drawn in FIG. 2 is having two characteristic domains of flat surface at edge part and cone well shape at center part in the emitter hole. The edge part domain and the center part domain are called as a doughnut-like domain 8 and a cone well shape domain 9, respectively. The cathode wiring 4 which is a conductive electrode containing silver is arranged in the upper surface of the 1.1 mm thickness glass substrate of the cathode panel 1. The thickness of the cathode wiring and the gate wiring are 5 microns and 1 microns, respectively. The thicknesses of the gate insulation film and the electron emission film are 20 microns and 1 micron, respectively. The silver contain cathode wiring at the center part of the emitter hole is lacked as shown in FIG. 3. The whole part of the emitter hole bottom is covered by an electron emission film 6. The depths measured from the gate wiring surface level at the center and at the edge are 50 microns and 20 microns, respectively.

### The Second Embodiment

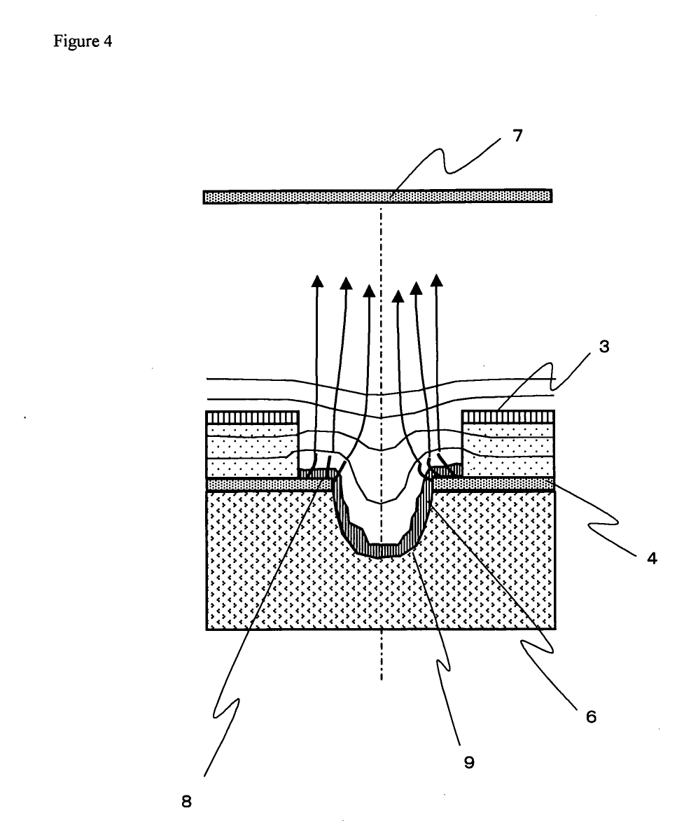

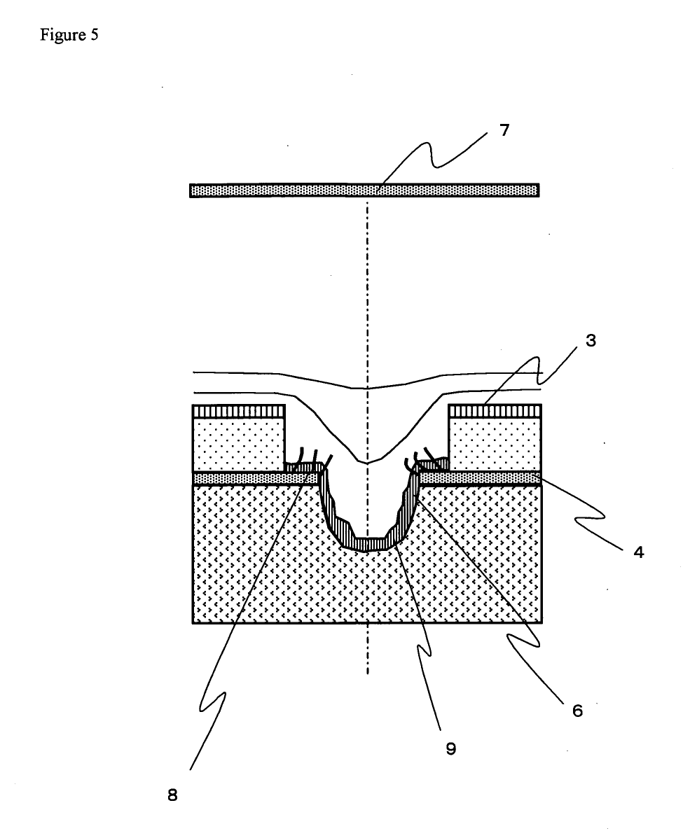

The embodiment 2 of this invention is drawn in FIG. 4 and FIG. 5. It is the example which actually applied voltage to the electron emission device of the structure of FIG. 3. In FIG. 4, −30V, +30V and 6 kV are applied on the cathode wiring, the gate wiring, and the fluorescence panel, respectively. An equipotential surface is drawn on FIG. 4. Since the electric field above the doughnut-like domain 8 is high field, the doughnut-like domain surface emits electrons. On the contrary, since the electric field above the cone well shape domain 9 is low field, the cone well shape domain does not emit electrons. In FIG. 5, 0V, +30V and 6 kV are applied on the cathode wiring, the gate wiring, and the fluorescence panel, respectively. An equipotential surface is drawn on FIG. 5. Since the electric fields above both the doughnut-like domain 8 and the cone well shape domain 9 are low field, the electron emission film 6 does not emit electrons in whole area.

### The Third Embodiment

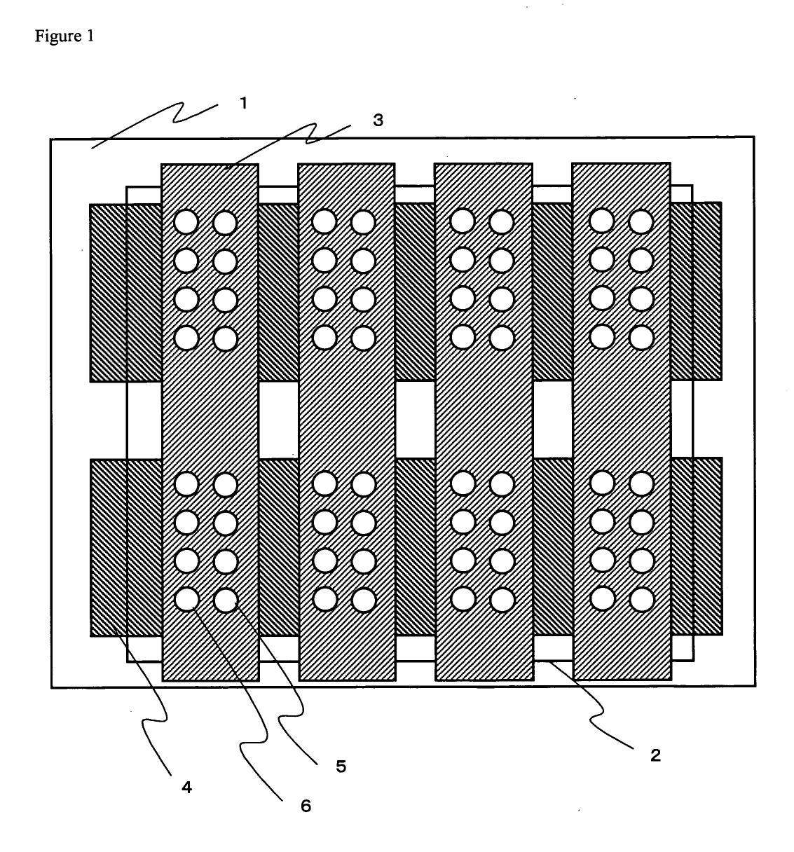

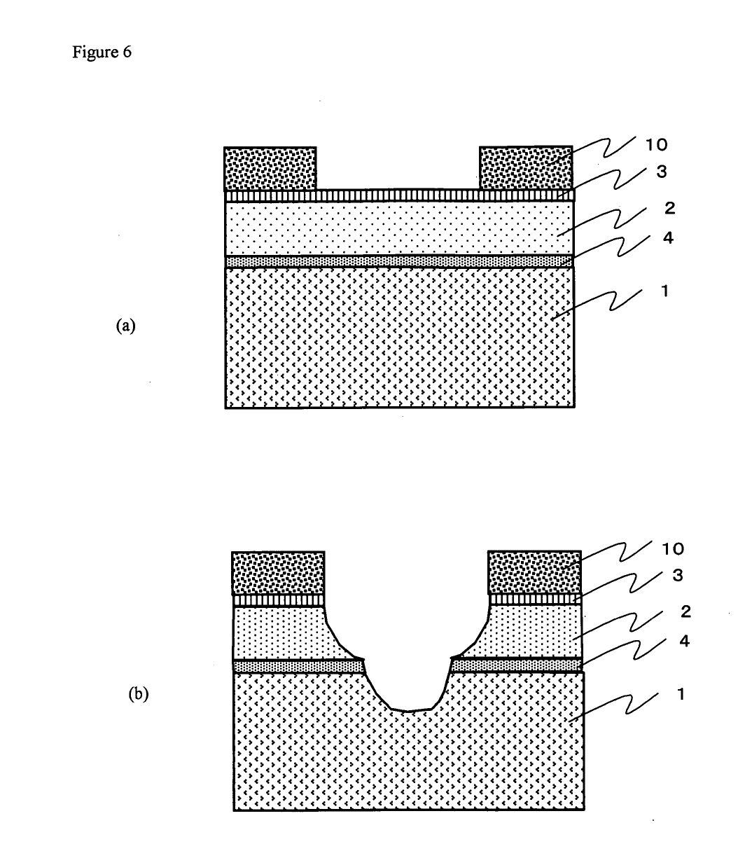

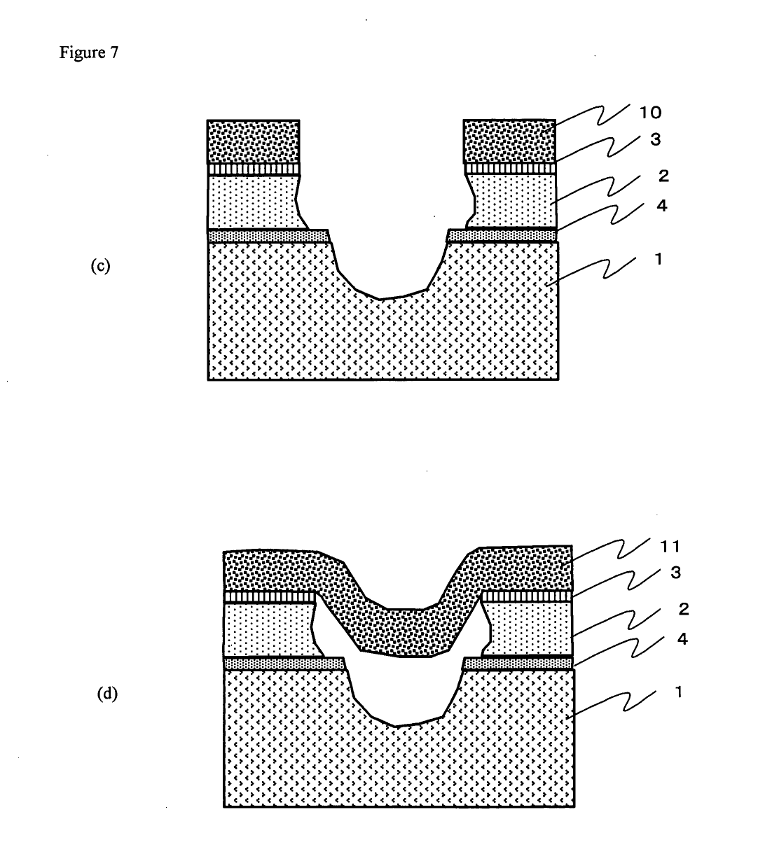

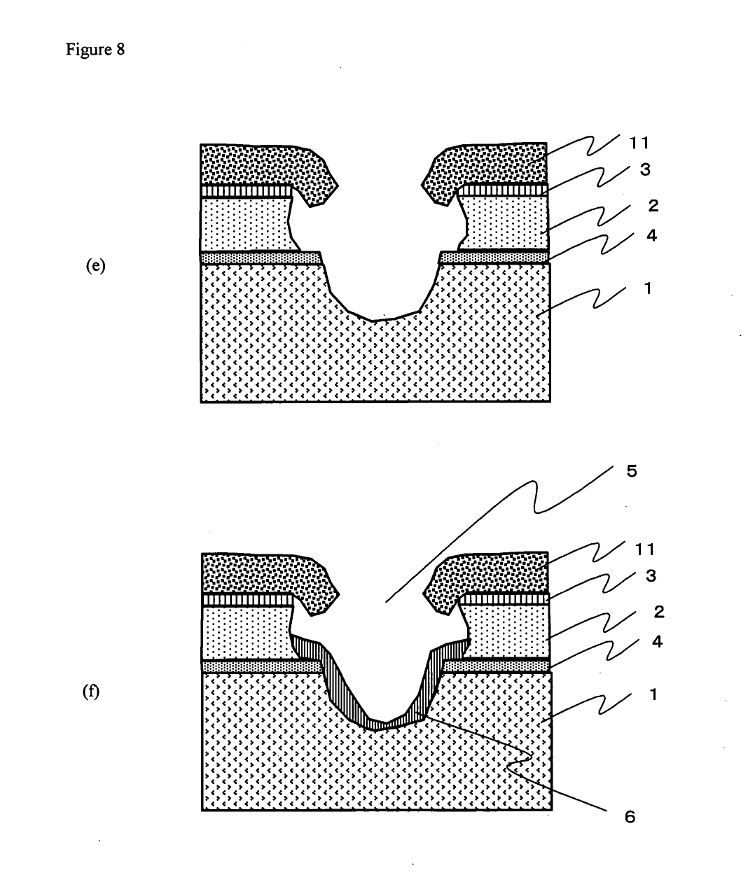

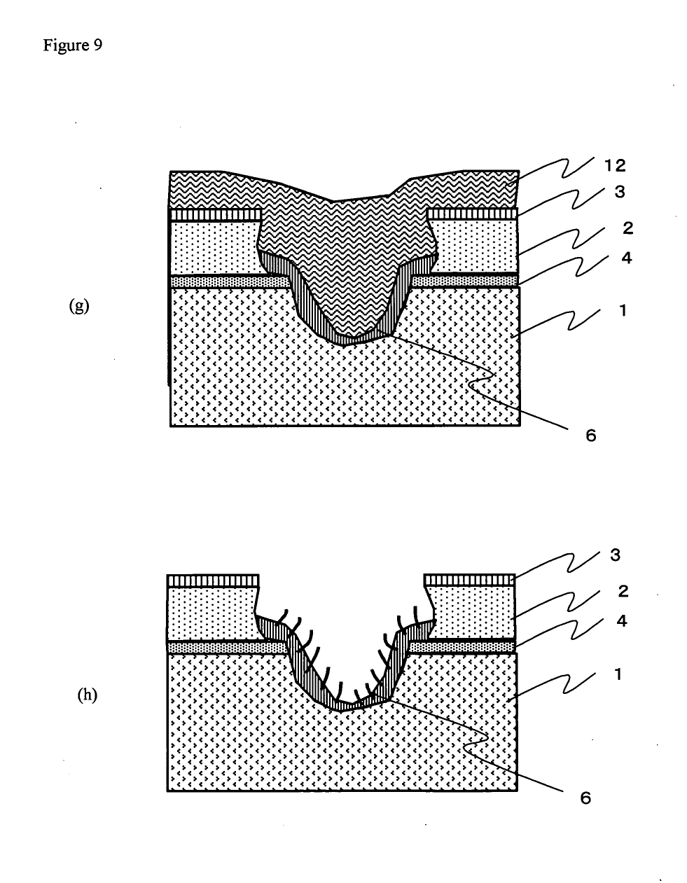

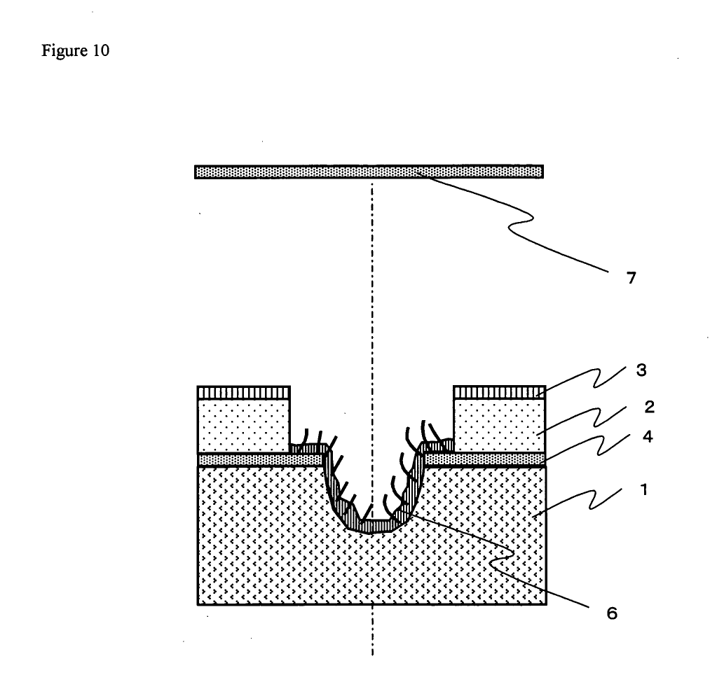

The embodiment 3 of this invention is drawn in from FIG. 6 to FIG. 10. The embodiment is a process method for this invention structure. FIG. 1 (a) shows a photo lithography process. On a cathode panel, a cathode wiring 4, a gate insulation film 2, and a gate wiring 3 are deposited from bottom side to top side. Then photo resist film 10 is covered on the top. Next the photoresist film is patterned by a conventional photo lithography method. FIG. 1 (a) shows the cross sectional view after the photolithography step. FIG. 1 (b) shows a cone well shape etching process step. By using blast etching method, the gate wiring, the gate insulation film, the cathode wiring, and the cathode panel are etched like cone well shape shown in FIG. 6(b). The depth at the center area is more than twice of the gate insulation film thickness. FIG. 7(c) shows a insulation film selectively etching process step. At this step, the insulation film in the emitter hole is etched by soft sand blast method. The cathode wiring is hard material of a silver paste. And the gate insulator film is soft material of a glass paste. Then the gate insulator film can be selectively etched by using middle hardness blast sands. After this selective etching process, the cathode wiring surface is exposed like ring (doughnut-like) shape. FIG. 7(d) and FIG. 8 (e) show a dry film laminating and patterning process steps. The dry film is covered against emission material spray deposition. FIG. 7(d) shows the lamination process step. FIG. 8(e) shows the patterning process step. The feature of the cover film 11 is its over hang shape. The cover film covers the gate wiring and top corner part of the emitter hole. FIG. 8(f) shows an electron emission film spray coating process step. A CNT paste is deposited by spray gun in the emitter hole 5. The electric conductive CNT paste contacts the cathode wiring and does not contact the gate wiring. FIG. 9(g) shows an activating the electron emission film process step. A sticky paste 12 is deposited on the electron emission film 6. FIG. 9(h) shows the structure after removing the sticky paste from the electron emission film. A part of the electron emission film surface is removed. The electron emission film has a lot of perpendicular standing CNTs like goose bumps. FIG. 10 (i) shows a final structure of embodiment 3.

What is claimed is:

1. An electron emission device which is composed by an insulated board in which a cathode electrode, an electron emission film, a gate insulation film, and a gate electrode were arranged, and an anode electrode estranged above said insulated board, and characterized by that an electron emission film is exposed to a bottom of an emitter hole provided in said gate insulation film on said insulated board, and an electron emission film in a part for an emitter hole central part being in a low position rather than an electron emission film of an emitter hole deep pool contiguity portion.

2. An electron emission device which is composed by an insulated board in which a cathode electrode, an electron emission film, a gate insulation film, and a gate electrode were arranged, and an anode electrode estranged above said insulated board, and characterized by that an electron emission film is exposed to a bottom of an emitter hole provided in said gate insulation film on said insulated board, and an electron emission film upper surface of an emitter hole deep pool contiguity portion being in a position higher than an emitter hole central part upper surface.

3. A manufacture method of an electron emission device of claims 1 or 2, at first, an electric conduction layer as a cathode electrode is arranged on an insulated board, secondly, depositing a gate insulation film on it, thirdly, arranging a gate electrode, fourthly, arranging a photo sensitive resist film, fifthly, exposing UV light with photo-mask on the photo sensitive resist, sixthly, etching the exposed gate insulation film in a cylindrical hole shape and seventhly additionally etching the gate insulation film in a cone hole shape with same axis as the cylindrical hole to make an emitter hole, eighthly, depositing an electron emission film on said emitter hole position.
